(19) United States
(12) Patent Application Publication
(10) Pub. No.: US 2014/0188468 A1
(43) Pub. Date: Jul. 3, 2014

(54) APPARATUS, SYSTEM AND METHOD FOR CALCULATING PASSPHRASE VARIABILITY

(71) Applicants: Dmitry Dyrmovskiy, Moscow (RU); Mikhail Khitrov, Saint-Petersburg (RU)

(72) Inventors: Dmitry Dyrmovskiy, Moscow (RU); Mikhail Khitrov, Saint-Petersburg (RU)

(21) Appl. No.: 13/729,127

(22) Filed: Dec. 28, 2012

(51) Int. Cl. G10L 17/00

(52) U.S. Cl. CPC G10L 17/005
USPC 704/235; 704/246; 704/250

(57) ABSTRACT

An apparatus, system and method for calculating passphrase variability are disclosed. The passphrase variability value can then be used for generating phonetically rich passwords in text-dependent speaker recognition systems, or for estimating the variability of the input passphrase in text-independent system during the enrolling process in a speech recognition security system.

### BACKGROUND OF THE INVENTION

1. Field of the Present Invention

The present invention relates generally to speaker recognition technology, and more particularly, to systems that compare a user's voice to a pre-recorded voice of another user and generate a value representative of the similarities of the voices.

2. Background

Speaker recognition is the process of automatically recognizing who is speaking on the basis of individual information included in speech signals. It can be divided into speaker identification and speaker verification. Speaker identification determines which registered speaker provides a given utterance from amongst a set of known speakers. Speaker verification accepts or rejects the identity claim of a speaker to determine if they are who they say they are. Speaker verification can be used to control access to restricted services, for example, phone access to banking, database services, shopping or voice mail, and access to secure equipment.

The technology is commonly employed by way of a user speaking a short phrase into a microphone. The different acoustic parameters (sounds, frequencies, pitch and other physical characteristics of the vocal tract, etc., often called “acoustic features”) are then measured and determined. These elements are then utilized to establish a set of unique user vocal parameters (often called a “voiceprint” or a “speaker model”). This process is typically referred to as enrolling. Enrollment is the procedure of obtaining a voice sample. The obtained voice sample is then processed (i.e. transformed to the corresponding voiceprint) and the voiceprint is then stored in combination with the user's identity for use in security protocols.

For example, during the verification process, the speaker is asked to repeat the same phrase used during the enrolling process. The voice verification algorithm compares the speaker's voice signature to the pre-recorded voice signature established during the enrollment process. The voice verification technology either accepts or rejects the speaker's attempt to verify the established voice signature. If the voice signature is verified, the user is allowed security access. If, however, the voice signature is not verified, the speaker is denied security access.

Speaker verification systems can be text dependent, text independent, or a combination of the two. Text dependent systems require a person to speak a predetermined word or phrase. This information, (typically called “voice password”, “voice passphrase”, “voice signature”, etc.) can be a piece of information such as a name, a place of birth, a favorite color or a sequence of numbers. Text independent systems recognize a speaker without requiring a predefined pass phrase.

There are a number of different techniques that are used to construct voiceprints: hidden Markov models (HMMs), Gaussian Mixture Models (GMMs), artificial neural networks or combinations thereof

One problem with the speaker recognition technology described above is the voice password (voice passphrase, voice signature) variability. A voice passphrase can be phonetically rich or phonetically poor. A “phonetically poor passphrase” means that this passphrase contains only a limited number of unique sounds (phonemes) and, correspondingly, the variability of this passphrase is low. If the passphrase variability is low (in the critical case the passphrase contains only a set of identical sounds, for example, “a-a-a-a”), it is impossible to estimate the adequate physical characteristics of the speaker's vocal tract. As a result, an inefficient voiceprint is created, and the efficacy of the speaker recognition system degrades sharply.

It should be noted that this problem is different from the problem of cryptographic security for a text password. Indeed, if a text password contains a limited number of unique text characters (in the critical case a set of identical characters, for example, “qqqqq”), its cryptographic security is dramatically low. But this only means that this password is easily guessable by an attacker and, correspondingly, is not strong enough to thwart cryptographic attacks.

In contrast, a speaker recognition system may be unable to create an efficient voiceprint due to the lack of acoustic sounds in a passphrase. The result of the “poor” voiceprint usage during the verification or identification process is poor speaker recognition quality. For example, one of the commonly used probabilistic coefficients to characterize a recognition system's performance is Equal Error Rate (EER). The lower the EER, the better the recognition system. It has been found that EER can be increased from 6% for phonetically rich passphrases to 18% for phonetically poor passphrases.

Consequently, there is a need for an apparatus, system and method for calculating passphrase variability. The passphrase variability value can then be used for generating phonetically rich passwords in text-dependent speaker recognition systems, or for estimating the variability of the input passphrase in text-independent system during the enrolling process and for generating a warning message to the speaker in case of low passphrase variability.

### SUMMARY OF THE INVENTION

The present invention includes an apparatus, system and method for determining passphrase variability. The determined passphrase variability value can then be used for generating phonetically rich passwords in text-dependent speaker recognition systems, or for estimating the variability of the input passphrase in text-independent system during the enrolling process and for generating a warning message to the speaker in case of low passphrase variability.

In a first aspect present invention includes a method of calculating a passphrase variability, including receiving an acoustic passphrase from a user, calculating a sequence of predetermined acoustic features using the voice passphrase and calculating a passphrase variability using the acoustic features.

In a second aspect, the present invention includes method of calculating a passphrase variability, including generating a text passphrase, calculating a sequence of predetermined acoustic feature using the text passphrase and calculating the passphrase variability using the acoustic features.

In some embodiments the calculated variability can then be used to prompt the user that the input acoustic passphrase needs to be changed or as a signal to the text password generator to regenerate the text password.

In a first embodiment, the present invention includes a method for calculating passphrase variability in a speech recognition system, including receiving a voice passphrase from a user, determining a sequence of predetermined acoustic features using the voice passphrase, determining a passphrase variability using the acoustic features, comparing the determined voice passphrase variability with a predetermined threshold, and reporting to the user the result of the comparing step.

In some embodiments there is the step of transforming voice passphrase into a sequence of spectrums, the step of transforming the sequence of spectrums into a first sequence of formants and the step of calculating an N-Dim histogram for each of the formant trajectories.

In some embodiments there is the step of calculating a minimum value for each formant and calculating a maximum value for each formant, the step of deriving at least one set of bins of hypercube and the step of coordinating a place of each formant as a single unit in the corresponding set of bins of hypercube.

In some embodiments there is the step of using the N-Dim histograms to calculate an entropy and a maximum value for said entropy.

In some embodiments the step of receiving a voice passphrase further includes receiving a digital signal as the voice passphrase.

In some embodiments the step of receiving a voice passphrase further includes receiving an analog signal as the voice passphrase.

In some embodiments there includes the step of receiving a text passphrase, the step of using speech synthesis to create the text passphrase and the step of creating an artificial phonogram with the text passphrase.

In some embodiments there includes the step calculating a second set of formant trajectories with the artificial phonogram, the step of calculating at least two phonetic variability values including absolute pseudo entropy and relative pseudo entropy.

In some embodiments there includes the step of generating the text passphrase using a phonemes method, the step of transforming the text passphrase into a sequence of phonetic symbols and the step of calculating text passphrase variability using the sequence of phonetic symbols.

In a second embodiment, the present invention includes a computer apparatus having a computer-readable storage medium, a central processor and a graphical use interface all interconnected, where the computer-readable storage medium having computer-executable instructions to calculate passphrase variability in a speech recognition system, computer-executable instructions including to receive a passphrase from a user, to determine a sequence of predetermined acoustic features using the voice passphrase, to determine a passphrase variability using the a set of predetermined features, to compare the determined passphrase variability with a predetermined threshold and report to the user the result of the comparison between the passphrase variability with a predetermined threshold.

In some embodiments the passphrase is a voice passphrase, and can be either composed of a digital signal, composed of an analog signal or composed of text.

In some embodiments the computer-executable instructions further include instructions to transform the passphrase into a sequence spectrum and to transform the sequence of spectrums into a first sequence of formants.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

The figures show the embodiments of the invention which are currently preferred; however we should note that the invention is not limited to the precise arrangements that are shown.

FIG. 1A is a block diagram showing an exemplary computing environment in which aspects of the present invention may be implemented;

FIG. 1B illustrates a logical block diagram of a computing device for passphrase variability calculation in accordance with an embodiment of the inventive arrangements disclosed herein;

FIG. 2 is a flow chart of a method for creating and using spoken free-form passwords to authenticate users in a text-independent system in accordance with an embodiment of the inventive arrangements disclosed herein;

FIG. 3A is a flow chart of a method for creating and using spoken free-form passwords to authenticate users in a text-dependent system accordance with an embodiment of the inventive arrangements disclosed herein;

FIG. 3B is an expanded flow chart of step 303 from FIG. 3A showing the steps associated with calculating phonetic variability in accordance with an embodiment of the inventive arrangements disclosed herein;

FIG. 4A is a block diagram of diagram of a computing device for calculating of generated voice passphrase variability in accordance with an embodiment of the inventive arrangements disclosed herein;

FIG. 4B is an expanded flow chart of step 403 from FIG. 4A showing the steps associated with calculating phonetic variability in accordance with an embodiment of the inventive arrangements disclosed herein;

FIG. 5 is block diagram of a phonemes method of calculating the generated passphrase variability without using speech synthesis in accordance with an embodiment of the inventive arrangements disclosed herein;

FIG. 6 is block diagram of a formants method of calculating the generated passphrase variability without using speech synthesis in accordance with an embodiment of the inventive arrangements disclosed herein;

FIG. 7 is a diagram illustrating an Equal Error Rate (EER) as a function of Informational variability in accordance with an embodiment of the inventive arrangements disclosed herein;

FIG. 8 is a diagram illustrating an Equal Error Rate (EER) as a function of Absolute variability in accordance with an embodiment of the inventive arrangements disclosed herein;

FIG. 9 is a diagram illustrating Equal Error Rate (EER) as a function of Relative, 1-st weighted sum and 2-nd weighted sum variability; and

FIG. 10 shows various tables illustrating Numerical data Equal Error Rate (EER) as a function of different Variabilities in accordance with an embodiment of the inventive arrangements disclosed herein.

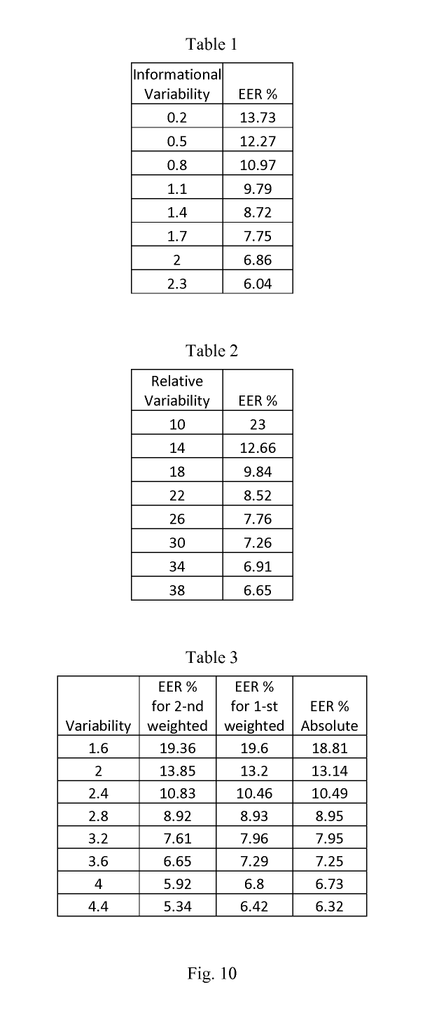

### DETAILED DESCRIPTION OF THE PREFERRED EMBODIMENTS

The present disclosure will now be described more fully with reference to the Figures in which the preferred embodiment of the present disclosure is shown. The subject matter of this disclosure may, however, be embodied in many different forms and should not be construed as being limited to the embodiments set forth herein.

Exemplary Operating Environment

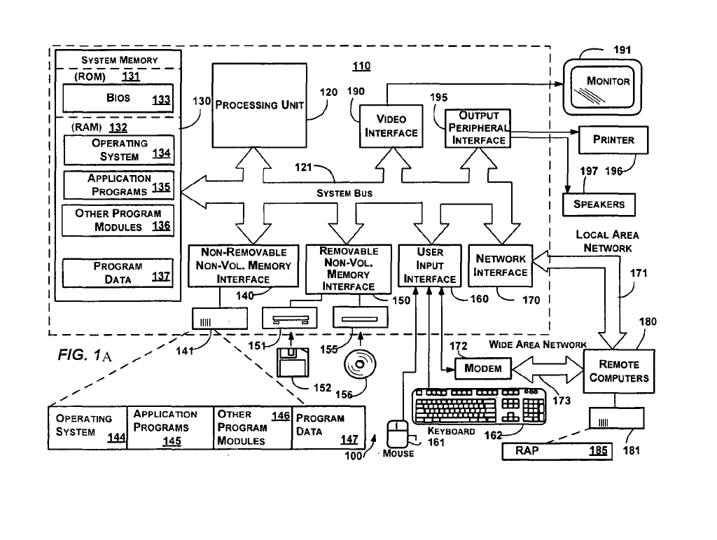

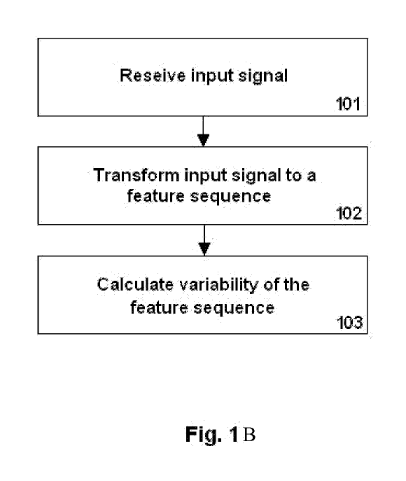

FIG. 1A illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1A, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1A illustrates operating system 134, application programs 135, other program modules 136, and program data 137.

The computer 110 may also include other removable/non-removable, volatile/nonvolatile computer storage media. By way of example only, FIG. 1A illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1A, provide storage of computer-readable instructions, data structures, program modules, and other data for the computer 110. In FIG. 1A, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1A. The logical connections depicted in FIG. 1A include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1A illustrates remote application programs 185 as residing on memory device 181. It will be appreciated that the network connections shown are exemplary and other means of establishing a communications link between the computers may be used.

Referring now to FIG. 1B, there is shown method steps for the apparatus to receive an input signal in step 101. In one embodiment, the input signal may be received by system 110 via an acoustic communication device, such as a telephone, modem, microphone or other well-known signal transfer device. It is likely that the signal received by system 110 is an acoustic input signal, although modern devices can transmit and receive digital signals. In some embodiments, the input signal may be received from an internal passphrase generator; in this case it can be a text input signal. The input signal is transformed to a corresponding sequence of acoustic features in step 102. In step 103, system 110 can be programmed to calculate the variability of the input signal using the sequence of acoustic features.

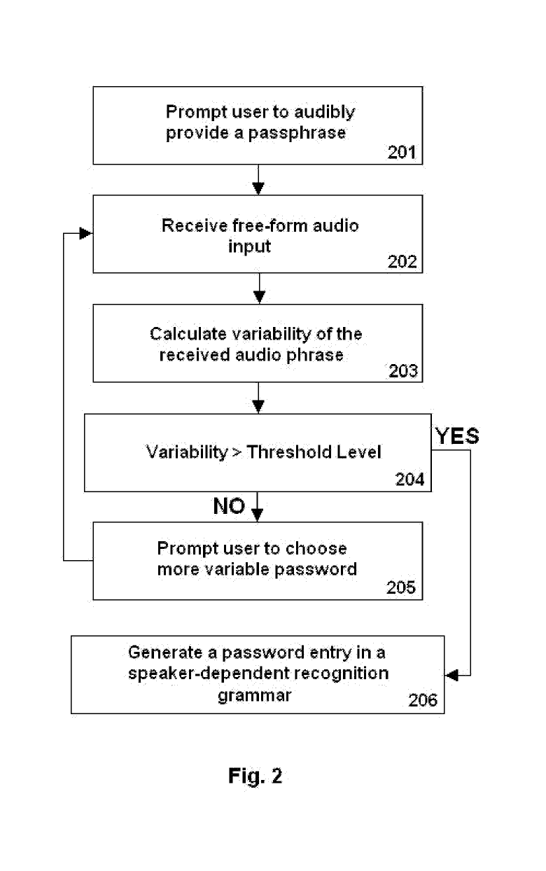

FIG. 2 shows a flow chart of a method for creating speech passphrases during the enrolling process in text independent systems. The passphrase establishment process can begin in step 201, where a user can be prompted to audibly provide an acoustic speech password. In step 202, audio input signal can be received in response to the password prompt. In step 203, the system 110 calculates the variability of the input signal. Next, the threshold unit 204 compares the calculated variability value with the predefined threshold level. When the calculated variability value meets or exceeds the threshold, the process can progress to step 206, where the password entry for the speaker is created and stored in a database, for example system memory 130. When the threshold is not exceeded, a warning message and a prompt to choose and input a new more variable password is generated in step 205, then the process can loop from step 205 to step 202, until the new password is received.

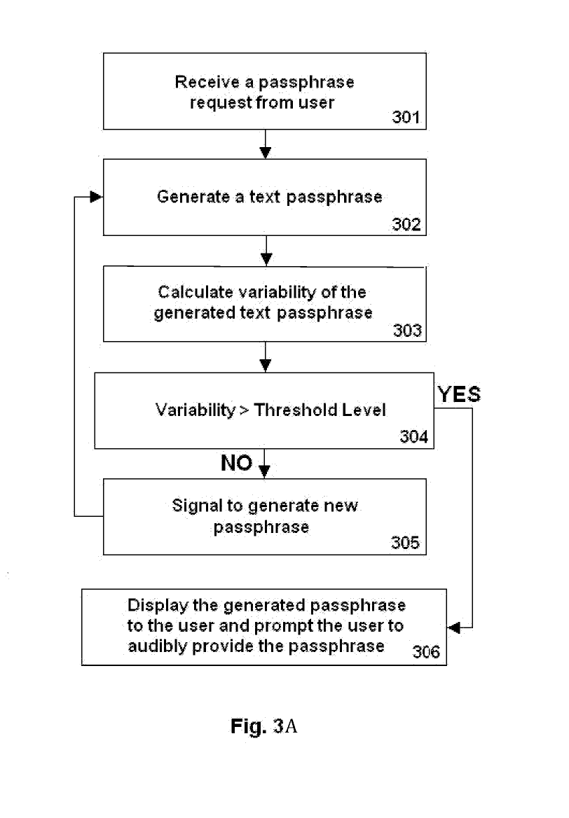

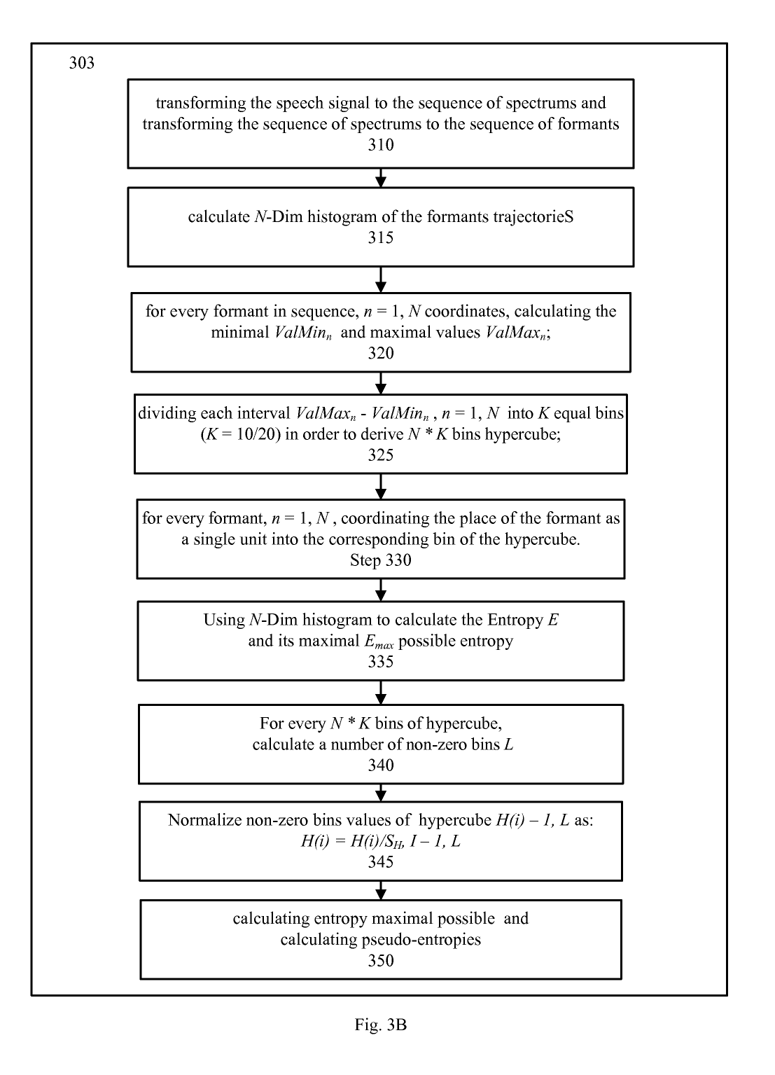

FIG. 3A shows a flow chart of a method for creating speech passphrases during the enrolling process in text dependent systems. The passphrase establishment process can begin in step 301, where the system is requested by a user to provide a voice passphrase. In step 302, the text passphrase is generated. Next, in step 303 the system 110 calculates the phonetic variability of the text passphrase as described below. Next, in step 304 the system 110 compares the calculated phonetic variability with a predetermined threshold level. When the calculated variability value meets or exceeds the threshold, the process can progress to step 306, where the generated text passphrase is displayed to the user with the prompt to speak. When the threshold is not exceeded, a signal to generate a new more variable password is created in step 305, then the process can loop from step 305 to step 302, until the new password with the variability higher than the threshold level is generated.

Referring now to FIG. 3B there is shown a preferred embodiment of calculating a value of phonetic variability a employing the following values:
(a) Absolute pseudo-entropy PE_{abs};
(b) Relative pseudo-entropy PEᵣₑₗ; and
(c) Weighted sum of (a) and (b).

The phonetic variability of the acoustic speech phrase can be calculated by transforming the speech signal to the sequence of spectrums and transforming the sequence of spectrums to the sequence of formants (i.e. formants trajectories) (step 310). A calculating step (step 315) is implemented to calculate N-Dim histogram of the formants trajectories, where preferably coordinates are 1-st, 2-nd, . . . , N-th formants, (where the value N can be equal to 2, 3, or more), by the following additional steps:
In step 320, for every formant in sequence, n=1,N coordinates, calculating the minimal ValMinₙ and maximal ValMaxₙ values;
In step 325, dividing each interval ValMaxₙ−ValMinₙ, n=1,N into K equal bins (K=10÷20) in order to derive N*K bins hypercube;
In step 330, for every formant, n=1,N coordinating the place of the formant as a single unit into the corresponding bin of the hypercube.
In step 335, using N-Dim histogram calculate the entropy E and its maximal possible entropy Eₘₐₓ by the following additional sub steps:
   In step 340, for every N*K bins of hypercube, calculating a number of non-zero bins L.
   In step 345, normalizing non-zero bins values of hypercube H(i), i=1,L as:

H(i)=H(i)/S_{H},i=1,L; where S_{H}=Σ^{L}ᵢ₌₁H(i).
In step 350, calculating entropy E as:

$$E = {\sum }_{i = 1}^{L} H ( i ) {log}_{2} \frac{1}{H ( i )}$$

and
   calculating entropy maximal possible Eₘₐₓ as: Eₘₐₓ=log₂ L
   Using E and Eₘₐₓ calculate pseudo-entropies, according to the formulas:
Absolute pseudo-entropy: PE_{abs}=M/(M(Eₘₐₓ−E)+1)
Relative pseudo-entropy: PEᵣₑₗ=MEI(MEₘₐₓ−(M−1)E), where M is the coefficient (equal to 1000, for example);
Calculating variability V by the following equations (three different choices): V=PE_{abs} (absolute variability) V=PEᵣₑₗ (relative variability) V=W₁PE_{abs}+W₂PEᵣₑₗ+W₃ (weighted sum variability); where the weighted coefficients are taken, for example, as: W₁=0.5; W₂=0.053; W₃=0.267.

In yet another embodiment, variability of a generated text passphrase can be evaluated by using speech synthesis or without using speech synthesis.

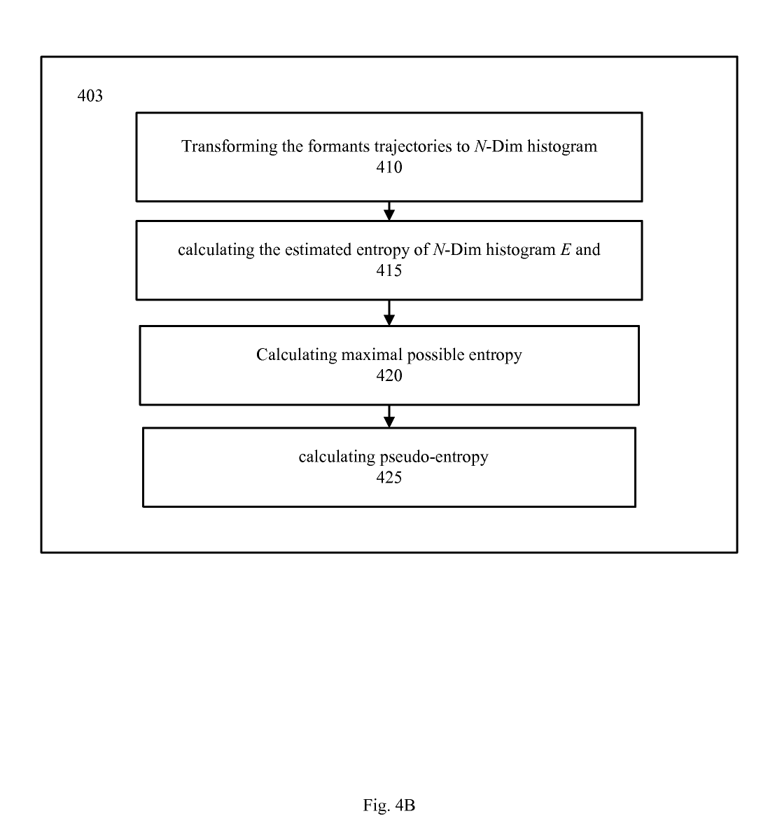

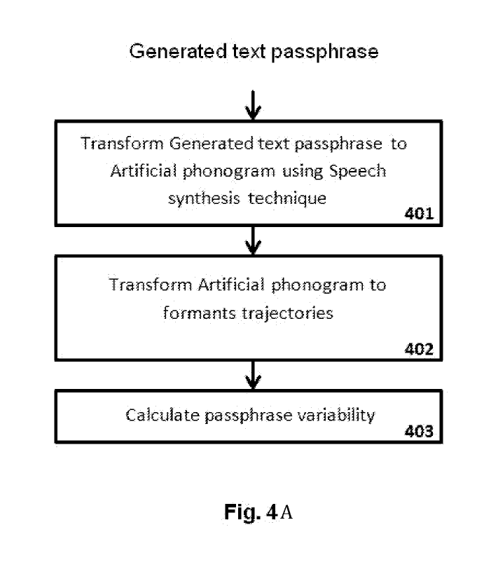

Referring now to FIG. 4A, there is shown the steps for generating a text passphrase using speech synthesis. In step 401 an artificial phonogram is created using the previous generated text passphrase and well-known algorithms of speech synthesis—i.e. Text-to-Speech transform is provided. In step 402 formants trajectories are calculated using this artificial phonogram. In step 403 formants trajectories are used to calculate two phonetic variability values:

Absolute pseudo-entropy PE_{abs}; and

Relative pseudo-entropy PEᵣₑₗ.

Referring now to FIG. 4B there is shown a preferred embodiment where Absolute pseudo-entropy and Relative pseudo-entropy are calculated using formants trajectories with the following steps:

Transforming the formants trajectories to N-Dim histogram (step 410), calculating the estimated entropy of N-Dim histogram E (step 415) and maximal possible entropy Eₘₐₓ (step 420) and calculating pseudo-entropy (step 425), according to the formulas:

Absolute pseudo-entropy: PE_{abs}=M/(M(Eₘₐₓ−E)+1)

Relative pseudo-entropy: PEᵣₑₗ=ME/(MEₘₐₓ−(M−1)E) where M is the coefficient.

In a preferred embodiment the formula to Calculate Variability V includes following equations:

V=PE_{abs}(absolute variability)

V=PEᵣₑₗ(relative variability)

V=W₁PE_{abs}+W₂PEᵣₑₗ+W₃(weighted sum variability); where weighted coefficients are taken, for example, as: W₁=0.5;W₂=0.053;W₃=0.267.

There are different methods of calculating the generated passphrase variability without using speech synthesis including the Phonemes method and the Formants method.

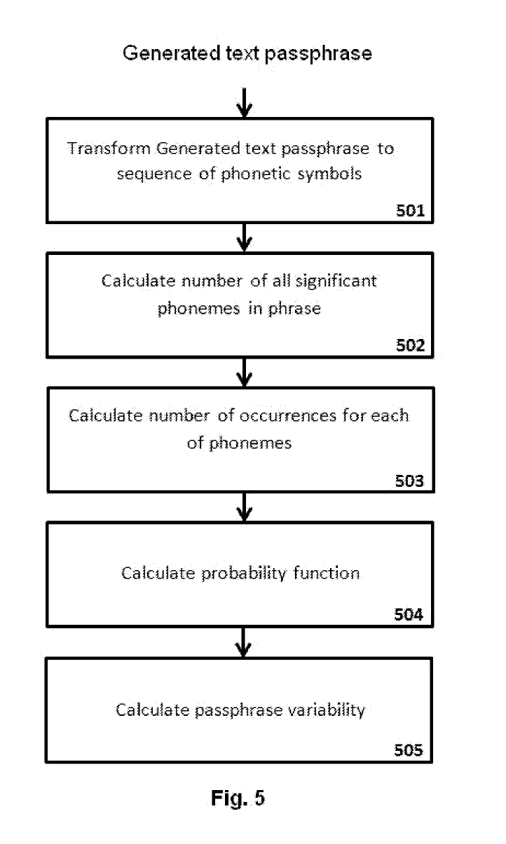

Referring now to FIG. 5 there is shown steps to generate a text passphrase with the phonemes method. In step 501 the generated text passphrase is transformed to a sequence of phonetic symbols (using pronunciation rules for the selected language). In step 502 passphrase variability is calculated using the sequence of phonetic symbols. It is impossible to calculate Absolute and Relative entropy in the case of phonemes method however as phonetic transcription is direct representation of the phrase to be spoken, it is possible to calculate the phrase variability as information entropy IE.

The steps to calculate informational entropy include transforming the generated text passphrase to the sequence of phonemes, calculating M the number of all significant phonemes in the sequence of phonemes (significant phonemes must be chosen beforehand, for example, as only phonemes of vowels, or phonemes of vowels and voiced nasal sounds, or phonemes of all voiced sounds, etc.) and calculating a number of occurrences for each of phonemes above n(i),i=1,M, where i is number of phoneme in the following list;

Calculate probability function: p(i)=n(i)/M;

Calculate information entropy IE=ρᵢ₌₁^{M}−p(i)log₂ p(i):—

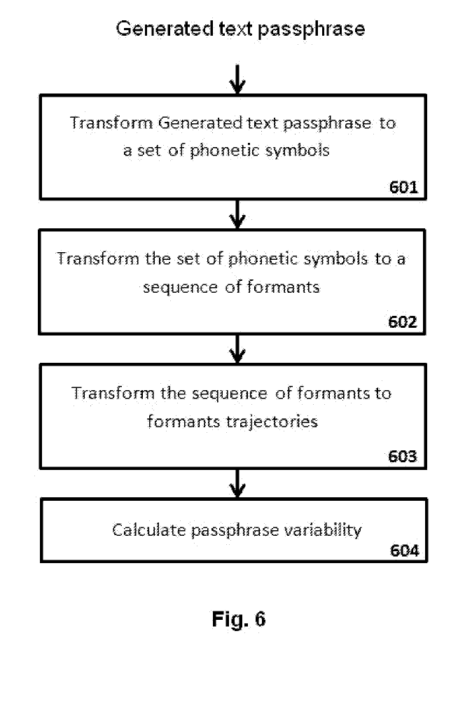

Referring now to FIG. 6 there is shown the steps to generate a text passphrase using the formants method, where passphrase variability is calculated almost the same way as in case when speech synthesis is used, but without “text-to-speech” step.

In step 601, the generated text passphrase is transformed to a sequence of phonetic symbols using pronunciation rules for the selected language. In step 601 every phoneme in the sequence of phonetic symbols is transformed directly to formants, using known algorithms. In step 602 sequence of formants are used to calculate formants trajectories and in step 603, the formants trajectories are transformed to N-Dim histogram. In step 604 the passphrase variability is determined by calculating the estimated entropy of N-Dim histogram E and maximal possible entropy Eₘₐₓ as described previously. In preferred embodiments calculating the pseudo-entropy includes using the formulas:

Absolute pseudo-entropy: PE_{abs}=M/(M(Eₘₐₓ−E)+1)

Relative pseudo-entropy: PEᵣₑₗ=ME/(MEₘₐₓ−(M−1)E) where M is the coefficient.

In the case of calculating the generated passphrase variability without using speech synthesis, the variability may be determined by the following equations (five different choices):

V=IE(information variability);

V=PEᵣₑₗ(relative variability);

V=PE_{abs}(absolute variability);

V=W₁PE_{abs}+W₂PEᵣₑₗ+W₃(first weighted sum variability); where weighted coefficients are taken, for example, as: W₁=0.5;W₂=0.053;W₃=0.267.

V=W₄PE_{abs}+W₅PEᵣₑₗ+W₆IE+W₇(second weighted sum variability); where weighted coefficients are taken, for example, as: W₄=0.33;W₅=0.0358;W₆=0.2541;W₇=0.7536.

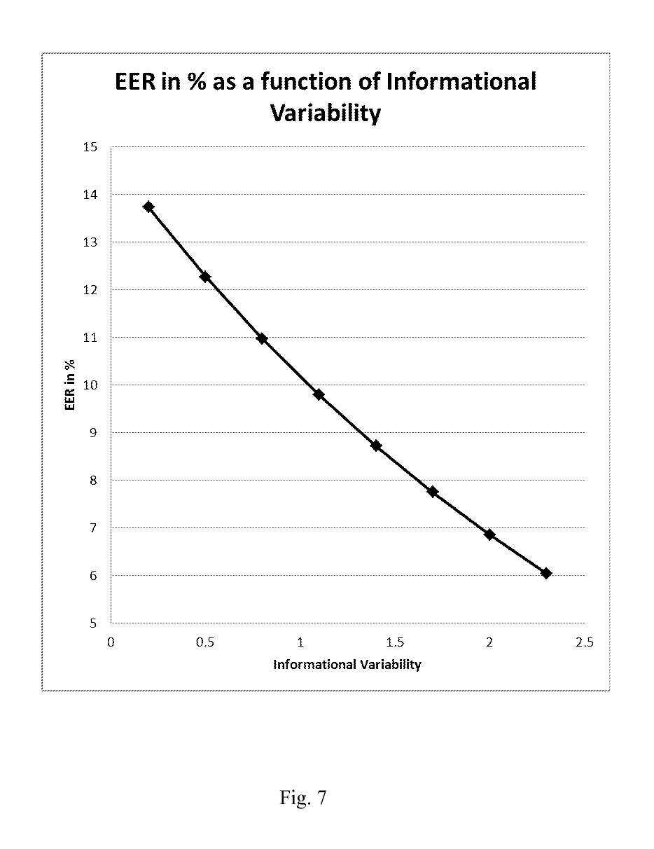

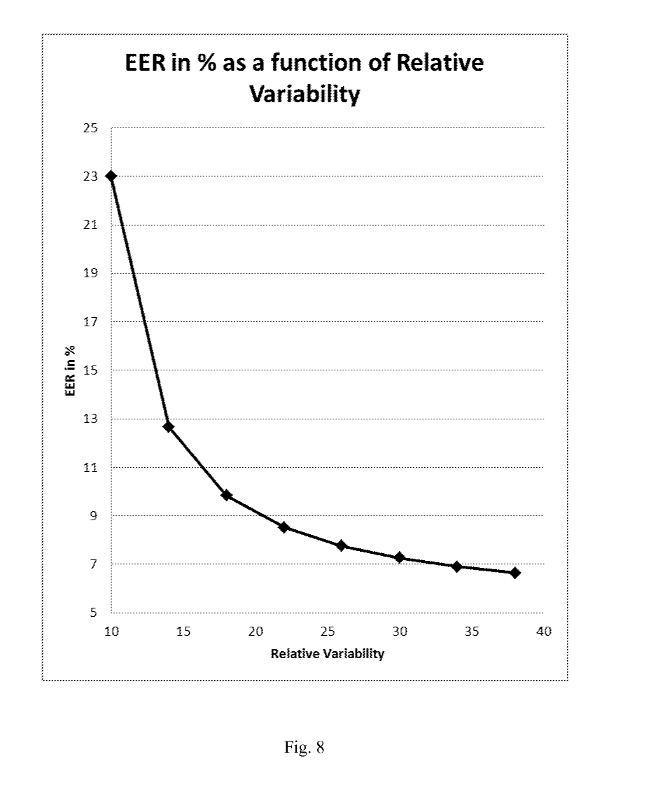

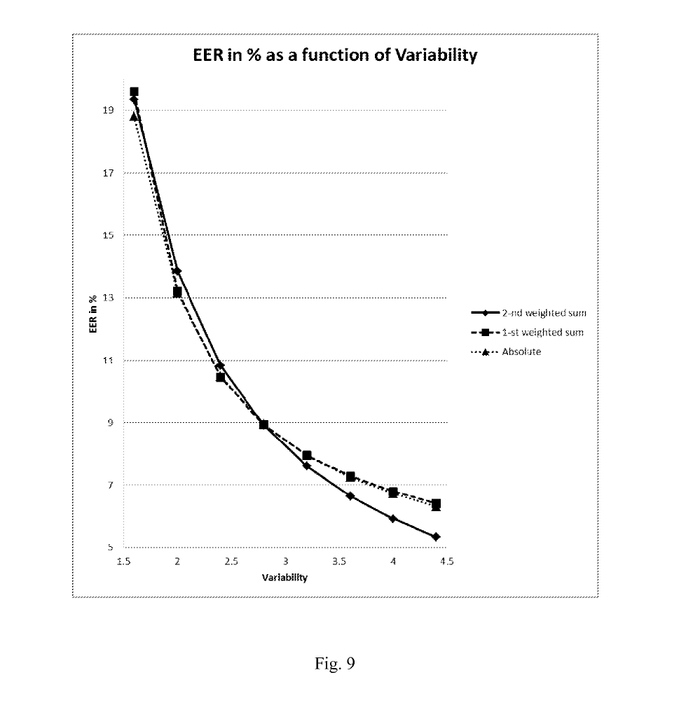

In FIGS. 7, 8, and 9 there are shown diagrams demonstrating the improvement of speaker identification system efficacy when voice passphrase variability evaluation is used to generate password with high variability. The diagrams scale the Equal Error Rate (EER) of the identification system as function of different Variabilities. As can be bee seen in the diagrams when passphrase variabilities increase the EER decreases significantly—i.e. system efficacy increases.

It will be apparent to one of skill in the art that described herein is a novel apparatus, system and method for calculating voice passphrase variability. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A method for calculating passphrase variability in a speech recognition system, the method comprising the steps of:
receiving a passphrase from a user;
determining a sequence of predetermined acoustic features using the passphrase;
determining a passphrase variability using the acoustic features;
comparing the determined passphrase variability with a predetermined threshold; and
reporting to the user the result of the comparing step.

2. The method according to claim 1, further comprising the step of transforming the passphrase into a sequence spectrums.

3. The method according to claim 2, further comprising the step of transforming the sequence of spectrums into a first sequence of formants.

4. The method according to claim 3, further comprising the step of calculating an N-Dim histogram for each of the formant trajectories.

5. The method according to claim 4, further comprising the step of calculating a minimum value for each formant and calculating a maximum value for each formant.

6. The method according to claim 5, further comprising the step of deriving at least one set of bins of hypercube.

7. The method according to claim 6, further comprising the step of coordinating a place of each formant as a single unit in the corresponding set of bins of hypercube.

8. The method according to claim 7, further comprising the step of using the N-Dim histograms to calculate an entropy and a maximum value for said entropy.

9. The method according to claim 1, where the step of receiving a passphrase further includes receiving a digital signal as the voice passphrase.

10. The method according to claim 1, where the step of receiving a passphrase further includes receiving an analog signal as the voice passphrase.

11. The method according to claim 1 further comprising the step of receiving a text passphrase.

12. The method according to claim 11 further comprising the step of using speech synthesis to create the text passphrase.

13. The method according to claim 12 further comprising the step of creating an artificial phonogram with the text passphrase.

14. The method according to claim 14 further comprising the step calculating a second set of formant trajectories with the artificial phonogram.

15. The method according to claim 15 further comprising the step of calculating at least two phonetic variability values.

16. The method according to claim 15 further comprising the step of calculating absolute pseudo entropy.

17. The method according to claim 16 further comprising the step of calculating relative pseudo entropy.

18. The method according to claim 11 further comprising the step of generating the text passphrase using a phonemes method.

19. The method according to claim 19 further comprising the step of transforming the text passphrase into a sequence of phonetic symbols.

20. The method according to claim 19 further comprising the step of calculating text passphrase variability using the sequence of phonetic symbols.

21. A computer apparatus having a computer readable storage medium, a central processor and a graphical use interface all interconnected, where the computer-readable storage medium having computer-executable instructions to calculate passphrase variability in a speech recognition system, computer-executable instructions comprising:
receive a passphrase from a user;
determine a sequence of predetermined acoustic features using the voice passphrase;
determine a passphrase variability using the a set of predetermined features;
compare the determined passphrase variability with a predetermined threshold; and
report to the user the result of the comparison between the passphrase variability with a predetermined threshold.

22. The computer apparatus according to claim 21 further where the passphrase is a voice passphrase.

23. The computer apparatus according to claim 22 further where the passphrase is composed of a digital signal.

24. The computer apparatus according to claim 22 further where the passphrase is composed of an analog signal.

25. The computer apparatus according to claim 21 further where the passphrase is a passphrase is a composed of text.

26. The computer apparatus according to claim 21, where the computer-executable instructions further comprises instructions to transform the passphrase into a sequence spectrums.

27. The computer apparatus according to claim 21, where the computer-executable instructions further comprises instructions to transform the sequence of spectrums into a first sequence of formants.

28. The computer apparatus according to claim 21, where the computer-executable instructions further comprises instructions to calculate an N-Dim histogram for each of the formant trajectories.

29. The computer apparatus according to claim 21, where the computer-executable instructions further comprises instructions to calculate a minimum value for each formant and calculating a maximum value for each formant.

30. The computer apparatus according to claim 21, where the computer-executable instructions further comprises instructions to derive at least one set of bins of hypercube.

31. The computer apparatus according to claim 21, where the computer-executable instructions further comprises instructions to coordinate a place of each formant as a single unit in the corresponding set of bins of hypercube.
